(19) United States
(12) Patent Application Publication
(10) Pub. No.: US 2020/0356421 A1
(43) Pub. Date: Nov. 12, 2020

(54) WEB APPLICATION PROGRAMMING INTERFACE DRIVER

(71) Applicant: SAP SE, Walldorf (DE)

(72) Inventors: Kumar Vikas, Bangalore (IN); Gregor Tielsch, Ilvesheim (DE)

(73) Assignee: SAP SE

(21) Appl. No.: 16/406,606

(22) Filed: May 8, 2019

(51) Int. Cl. G06F 9/54; G06Q 10/06

(52) U.S. Cl. CPC G06F 9/54; G06Q 10/06315

(57) ABSTRACT

A method, a system, and a computer program product for connecting computing components are disclosed. A computing component is selected from a plurality of computing components for communicatively coupling the computing component to a computing system. One or more application programming interfaces for communicatively coupling the selected computing component to the computing system are identified. Based on the identified application programming interfaces, one or more required application programming interfaces for communicatively coupling the selected computing component to the computing system are determined. One or more application programming interface drivers corresponding to the required application programming interfaces are identified. Using the identified application programming interface drivers, the selected computing component is communicatively coupled with the computing system. The selected component is activated for operation with the computing system.

### TECHNICAL FIELD

This disclosure relates generally to data processing and, in particular, to a web application program interface driver(s) for connecting multiple computing systems and/or platforms and/or domains.

### BACKGROUND

Computing systems rely on a multitude of computing components or data processing elements for performing of various tasks. Such computing components/elements may be connected using various application programming interfaces (APIs). The APIs may connect the components/elements of systems and provide appropriate communication, functional, data and/or other capabilities. However, using the existing APIs of computing systems, it may be difficult to implement/configure various computing components for proper operation in the event of updates or changes to as well as deletion of components. Thus, there is a need for a way to effectively connect computing components and/or processing elements in a computing environment.

### SUMMARY

In some implementations, the current subject matter relates to a computer implemented method for connecting various computing components. The method may include selecting a computing component from a plurality of computing components for communicatively coupling the computing component to a computing system, identifying one or more application programming interfaces for communicatively coupling the selected computing component to the computing system, determining, based on the identified one or more application programming interfaces, one or more required application programming interfaces for communicatively coupling the selected computing component to the computing system, identifying one or more application programming interface drivers corresponding to the one or more required application programming interfaces, and communicatively coupling, using the identified one or more application programming interface drivers, the selected computing component with the computing system and activating the selected component for operation with the computing system.

In some implementations, the current subject matter can include one or more of the following optional features. In some implementations, the computing system may include a plurality of bounded contexts. The selected computing component may be communicatively coupled with one or more bounded contexts in the plurality of bounded contexts.

In some implementations, the method may further include determining, based on the identified APIs, one or more optional APIs for communicatively coupling the selected computing component to the computing system, identifying one or more API drivers corresponding to the one or more optional APIs, and communicatively coupling, using the identified one or more API drivers corresponding to one or more required APIs and one or more optional APIs, the selected computing component with the computing system and activating the selected component for operation with the computing system.

In some implementations, the computing system may include a computing system API (e.g., an internal API) configured to be communicatively coupled to the identified one or more APIs.

In some implementations, the APIs may be identified based on at least one of the following: an operating system of the selected component, an operating system of the computing system, and any combination thereof.

In some implementations, the computing system may be an enterprise resource computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary enterprise system that may include one or more domains;

FIG. 2 illustrates an exemplary system, according to some implementations of the current subject matter;

FIG. 3 illustrates an exemplary data plane component that may be used to determining which APIs may be available, according to some implementations of the current subject matter;

FIG. 4 illustrates an exemplary control plane component that may be used to determining which API drivers may be required and/or optional, according to some implementations of the current subject matter;

FIG. 5 illustrates an exemplary method for determining required/optional application programming interfaces for the purposes of activating a computing component, according to some implementations of the current subject matter

FIG. 6 illustrates an exemplary system for establishing a connection between various computing components, according to some implementations of the current subject matter

FIG. 7 is a diagram illustrating an exemplary system including a data storage application, according to some implementations of the current subject matter;

FIG. 8 is a diagram illustrating details of the system of FIG. 7;

FIG. 9 is an exemplary system, according to some implementations of the current subject matter; and

FIG. 10 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide a web application program interface driver(s) for connecting multiple computing systems and/or platforms and/or domains.

In computing application, an application programming interface (API) may include a set of tools for building software, subroutine definitions, and/or communication protocols. It may also define methods of communication between various computing components. An API may be used to develop a computer program and provide the requisite building blocks that may be assembled by a developer. An API may be developed for a different types of systems, e.g., a web-based system, an operating system, a database system, a computer hardware, and/or a software library. An API specification may include specifications for routines, data structures, object classes, variables, remote calls, etc.

A web API may be an application programming interface for a web server and/or a web browser. A web API may be limited to a web application's client-side (which may include web frameworks being used), and might not include web server and/or browser implementation details, e.g., server application programming interface (SAPI). On the server side, a web API may include publicly exposed endpoints to a defined request-response message system (e.g., in JSON or XML). Endpoints may provide interaction with server-side web APIs and may specify where resources may be located that can be accessed by third party software. Further, a server-side web API may provide an interface for the outside world to interact with an internal business logic of a company. On a client-side, a web API may be a programmatic interface that may extend functionality within a web browser or other HTTP client (e.g., a native plug-in browser extension, standardized JavaScript binding, etc.).

Today, many companies rely on enterprise applications to conduct their business operations. Such application typically strive to meet companies' critical business objectives in order to deliver real value for its users. When these applications are developed, typically domain-driven design patterns may be implemented. As part of the design of an application, the focus lies on development of automation of the core business domains (e.g., expert design and refinement of conceptual models that address problems related to their business domains). A domain may be a body of knowledge, influence and/or activity, which may serve as an area of focus for the application developer.

The core domain include supporting domains or generic subdomains. The domains may typically establish one or more areas that may need to be modeled. Multiple models may interact with one another. Each model may have a boundary, which encompasses a bounded context. Bounded contexts may allow creation of logically consistent applications, e.g., one for each bounded context that may include own domain, code, and/or persistence mechanisms. Further, a bounded context may define a context within which each model is applicable, where different contexts might not directly interact with one another. Exemplary domains in a typical business may include, but are not limited to, sales, production, requisition, shipping, finance, human resources, etc.

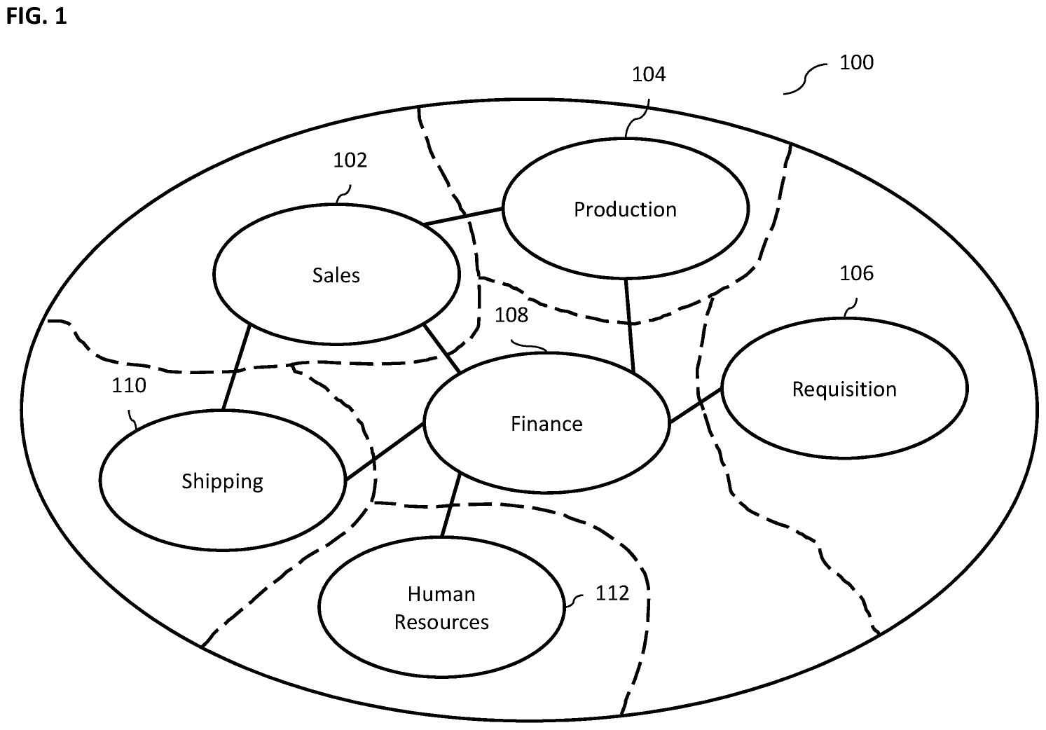

FIG. 1 illustrates an exemplary enterprise system 100 that may include one or more domains 102-112. One or more domains 102-112 may be configured to interact with one another. Interaction may be accomplished using one or more application programming interfaces.

As stated above, application programming interface(s) may provide one or more programming interfaces that may allow communication across network boundaries/domains in a distributed environment. These may include, for example, but not limited to, remote procedure(s), remote function(s), web API(s), etc. While the API of a library may be statically linked to a library, the web APIs are not linked statically at compile time. A server that hosts the APIs may need to preserve compatibility as long as a particular version of the API is active. Thus, a change to an existing version of an API that provides communication capabilities across domain boundaries to one or more domains and/or external applications may affect or even terminate the abilities of the domains/applications to communicate with one another. Hence, a new version of web API will need to be developed and implemented to ensure that communications continue. This may be a complicated process as it may involve content negotiation when replacing the old version of the web API with the new one. As a consequence, implementation of each new version of the web API may lead to increased development, implementation, installation, maintenance, etc. costs as well as compatibility issues and various other problems.

Each bounded context in an enterprise system may be configured to use multiple web API(s) (e.g., to communicate with different bounded contexts, external applications, third parties, etc.). To ensure that all of the services (e.g., applications, communications, etc.) of each bounded context continue to function as desired, the current subject matter may provide an ability for the web API(s) of the bounded contexts to be setup and communicate with one another to ensure continuity of operation. In some implementations, the web API(s) may include one or more driver computing components that may provide such setup and communication capabilities for the web API(s).

In some implementations, the web API(s) driver component capabilities may be configured to determine compatibilities of web API(s) and/or web services being provided by the domains. The driver components may ensure that existing versions of web API(s) are used for as long as possible, for example, until it is no longer possible to ensure that compatible interfaces exist between web services/applications in the domains of the enterprise system and/or with third party services. Once existing version(s) of web API(s) are no longer able to provide workable interfaces, new version(s) of web API(s) may be implemented. Such web API(s) versioning may allow changes in behavior between different web services/application. In some implementations, each next version of the web API(s) may correspond to significant changes in the consumption requirements (e.g., usage, communication, etc.). The applications/web services/third party applications may be provided with a specific version of the web API(s) for use so that an appropriate versions of the applications/web services/third party applications are being used.

In some implementations, the web API(s) driver component capabilities may be configured to ensure that changes to web API(s)/web services may correlate with changes to the bounded context. Each bounded context may use one or more web API(s) for interfacing, communicating, etc. with one another and/or applications, etc. Hence, any changes in one web API that may be involved in providing interfacing, communication, etc. capabilities to a particular bounded context may affect the entire network of web API(s) associated with that bounded context and/or other bounded contexts that may be interfacing/communicating with the bounded context.

To ensure that appropriate changes are propagated throughout, the web API driver may include a data plane component and a control plane component that may be configured to automate deployment and configuration of changes to corresponding web API(s), as will be discussed below. The changes may be propagated based on a knowledge of various characteristics of the enterprise system, e.g., platform, version of the platform, version of the service(s), etc.

In some implementations, the web API driver component may act as an intermediary between different technology platforms. The driver component may be configured to connect legacy systems, third party applications, etc.

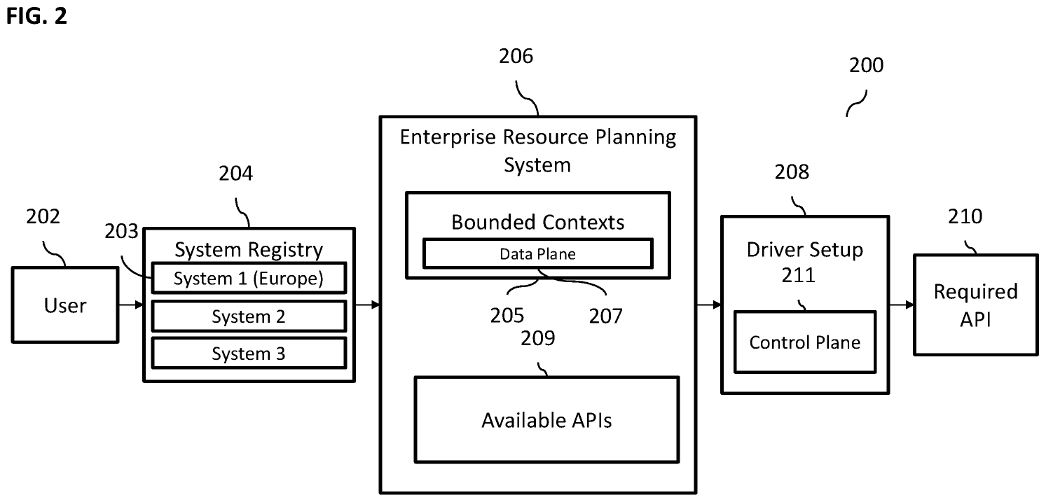

FIG. 2 illustrates an exemplary system 200, according to some implementations of the current subject matter. The system 200 may include a user component 202, a system registry component 204, an enterprise resource planning system component 206, a driver setup component 208, and a required API component 210. The components 202-210 may be part of the same computing system (e.g., an enterprise resource planning system) and/or part of different computing systems. The components 202-210 may be incorporated into one or more software, hardware and/or any combination thereof. The components may include one or more processors, memory locations, servers, databases, and/or any other computing components and/or any combinations thereof.

The user 202 may be any type of user, including but not limited to, an administrator, a computing program user, software application(s), business process(es), etc. The user 202 may be configured to select and/or activate one or more systems (e.g., System 1, System 2, System 3, etc.) 203 in the system registry component 204. The system 203 may be any type of system (e.g., such as one or more systems having bounded contexts shown in FIG. 1). The system component 204 may be an internal and/or an external (e.g., third party application) system that may be configured to be connected to one or more components (e.g., a “central requisition” system may be configured to be connected to “purchasing” system and/or any other system). A connection between systems may be accomplished through various communication protocols/links, including but not limited to, Simple Object Access Protocol (SOAP), Open Data Protocol (OData), Representational State Transfer (REST), and/or any other communication capabilities.

The enterprise resource planning system component 206 may include one or more bounded contexts 205 and a database 209 of various application programming interfaces that may be available for connecting the activated system (e.g., system 203) with one or more bounded contexts 207. The component 206 may use a data plane component 207 to determine which APIs may be available for connection to the activated system.

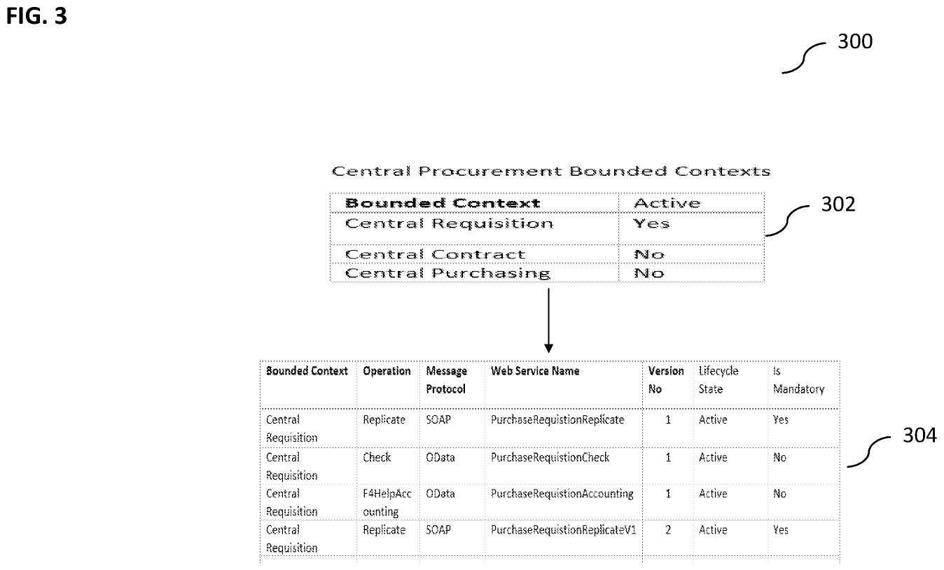

The data plane component 207 may be a database, a library, and/or any other type component that may identify APIs. FIG. 3 illustrates an exemplary data plane component 300 that may be used by the component 206 for determining which APIs may be available. As shown in FIG. 3, the data plane component 300 may be one or more tables that may configured to identify various bounded contexts (e.g., in the “Central Procurement” bounded contexts) for which various APIs may be available.

In some implementations, upon activation of the system 203, the current subject matter system may determine which bounded contexts may be have been activated. As shown in the table 302, a “central requisition” bounded context is now active. The remaining bounded contexts, i.e., “central contract” and “central purchasing” have not been activated. The current subject matter system may then determine which operations along with corresponding web services for the active bounded context (i.e., “central requisition”) may be active and/or may be mandatory. Corresponding messaging protocols may also be determined. As shown in table 304, in the central requisition bounded context, operations “replicate” along with “PurchaseRequisitionReplicate” (version 1) and “PurchaseRequisitionReplicateV1” (version 2) may be mandatory (i.e., required for operation of the bounded context and/or for communication among systems). The operations/services may require use of the SOAP communication protocol. The remaining operations (i.e., “Check” and “F4HelpAccounting”) that may correspond to web services of “PurchaseRequisitionCheck” (version 1) and “PurchaseRequisitionAccounting” (version 1), respectively, while being active, are not mandatory.

Referring back to FIG. 2, once the mandatory operations/services have been identified, driver setup component 208 may be configured to use a control plane component 211 to determine which APIs are required for operation with the connected system (e.g., system 203 as shown in FIG. 2). The required APIs may be outputted by the component 210. In addition to identifying required APIs, the control plan component 208 may also identify various optional APIs that may be used by the connected system.

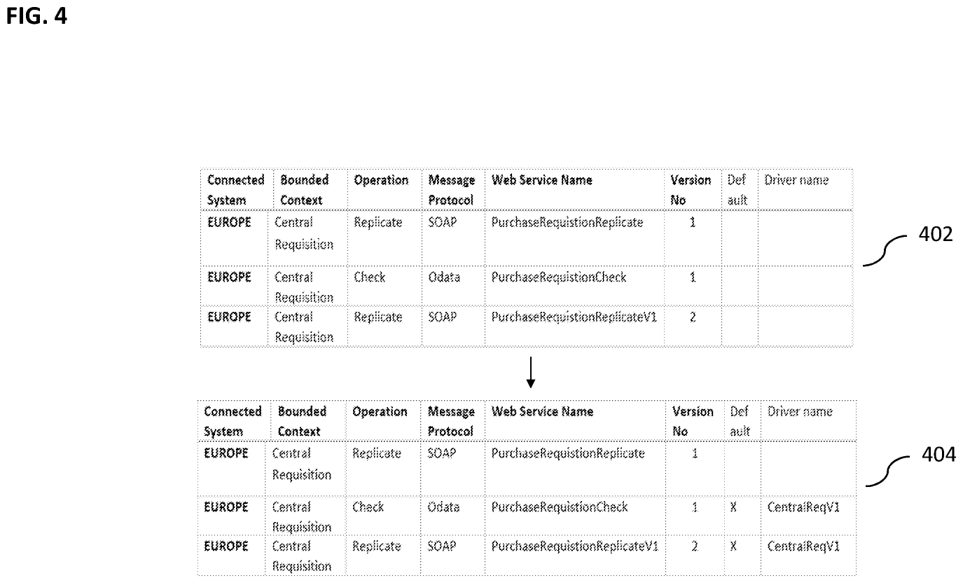

As shown FIG. 4, for the connected system 203 (e.g., “Europe”) to be connected to the bounded context “Central Requisition”, operations “Replicate”, “Check”, and “Replicate” along with corresponding web services “PurchaseRequisitionReplicate” (version 1), “PurchaseRequisitionCheck” (version 1), and “PurchaseRequisitionReplicateV1” (version 2) may be identified, where web service “PurchaseRequisitionCheck” (version 1) may be identified as optional (as per data plane component identifying is not being mandatory, as shown in FIG. 3), as shown in table 402. Appropriate communication protocols (i.e., SOAP and OData) may be identified as well.

Once the mandatory and optional services may have been identified, the current subject matter system may be configured to identify requisite drivers that may be used for connection of a particular web service to the connected system (i.e., “Europe”). In this case, as shown in table 404, the driver “CentralReqV1” may be used for the mandatory “PurchaseRequisitionReplicateV1” (version 2) web service API as well as the optional “PurchaseRequisitionCheck” (version 1) web service API. The drivers may be any type software code, software applications, programs, processes, etc.

Upon determination of mandatory and/or optional APIs along with corresponding drivers, configuration of associated computing components, web services, etc. and/or their activation in relation to the connected system may be performed. In some implementations, identification and/or selection of specific API (whether required and/or optional) may be performed based on various parameters associated with the connected system and/or the bounded contexts. These may include, but are not limited, to operating systems, processing capabilities, memory capacity, available data, type of connected system, type of the bounded context, specific communication protocols, and/or any other parameters, and/or any combinations thereof.

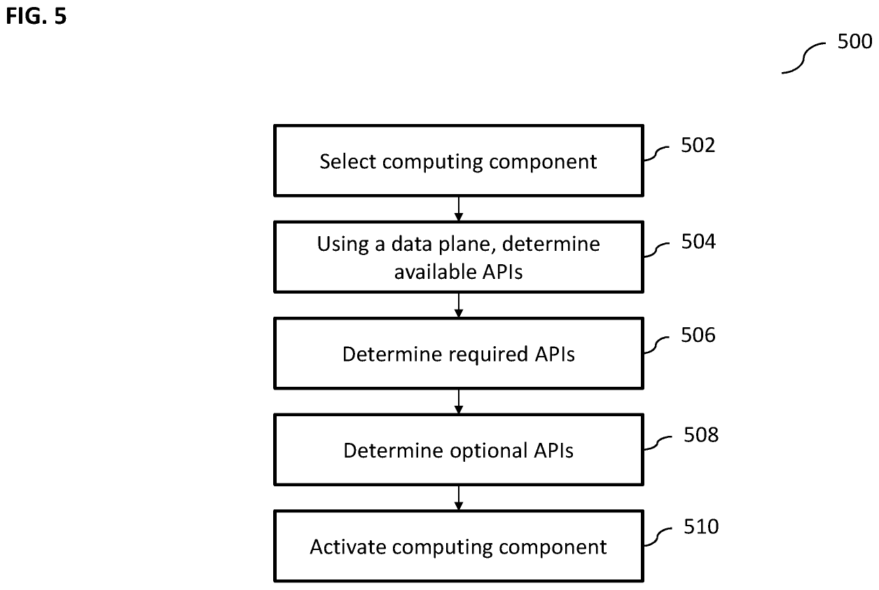

FIG. 5 illustrates an exemplary method 500 for determining required/optional application programming interfaces for the purposes of activating a computing component, according to some implementations of the current subject matter. At 502, a computing component may be selected. The computing component may be selected from a system registry 204 shown in FIG. 2. The computing component may be any type of computing component, system, software application, business process, and/or any other component. The component may be an internal component (e.g., a bounded context of an enterprise resource planning system)). To connect the selected computing component to a particular bounded context (e.g., within an enterprise resource planning system), the current subject matter may determine, at 504, available application programming interfaces that may be used for connecting the computing component to the bounded context. The application programming interfaces may be determined using the data plane component 207 (shown in FIG. 2). The data plane component may include all available mandatory and/or optional APIs that may be used for the purposes connection. In some implementations, the bounded context may also include its own internal APIs that may be configured for connection with one or more mandatory and/or optional APIs that may be identified by the data plane component.

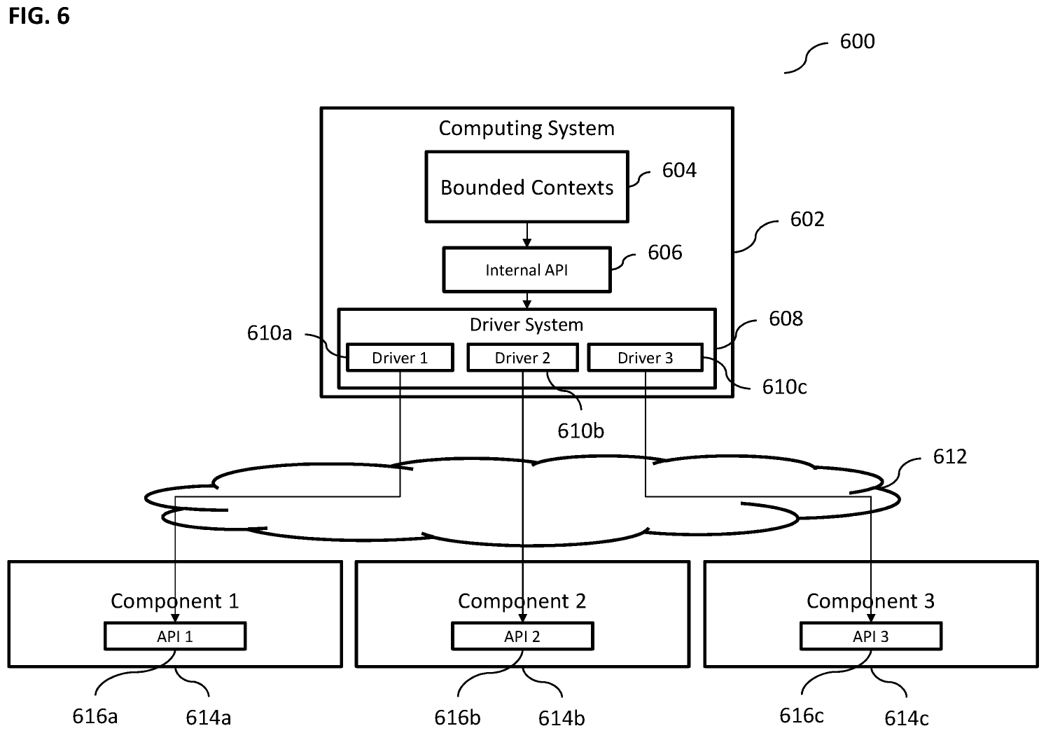

FIG. 6 illustrates an exemplary system 600 for establishing a connection between various computing components, according to some implementations of the current subject matter. The system 600 may include a computing system 602 that may have one or more bounded contexts that one or more computing components 1, 2, 3 614 (a, b, c) may wish to connect to. The system 602 may include one or more bounded contexts 604, one or more internal APIs 606 and driver system 608 that may include one or more API drivers 610 (a, b, c). Using the API drivers 610, the system 602 may be connected to one or more components 614. The connection may be established, using drivers 610, with corresponding APIs 616 of the components 614 (e.g., driver 610a may be used to connect with the API 616a of the component 614, and so on). The connections may be established using various communication protocols 612 (e.g., SOAP, OData, REST, etc.).

Referring back to FIG. 5, at 506, a control plane component (e.g., component 211 shown in FIG. 2) may be used to determine the required APIs for setting up a connection between the computing component and the bounded context. The required APIs may be those APIs that are mandatory to ensure operation of the computing component in tandem with the bounded context.

At 508, the control plane component may be used to determine any optional APIs that may be used for connection of the selected computing component with the bounded context. Upon determination of the required and/or optional APIs, corresponding API drivers may be identified and used for connection to of the computing component with the bounded context, thereby activating the computing component, at 510.

In some implementations, the current subject matter can be implemented in various in-memory database systems, such as a High Performance Analytic Appliance (“HANA”) system as developed by SAP SE, Walldorf, Germany. Various systems, such as, enterprise resource planning (“ERP”) system, supply chain management system (“SCM”) system, supplier relationship management (“SRM”) system, customer relationship management (“CRM”) system, and/or others, can interact with the in-memory system for the purposes of accessing data, for example. Other systems and/or combinations of systems can be used for implementations of the current subject matter. The following is a discussion of an exemplary in-memory system.

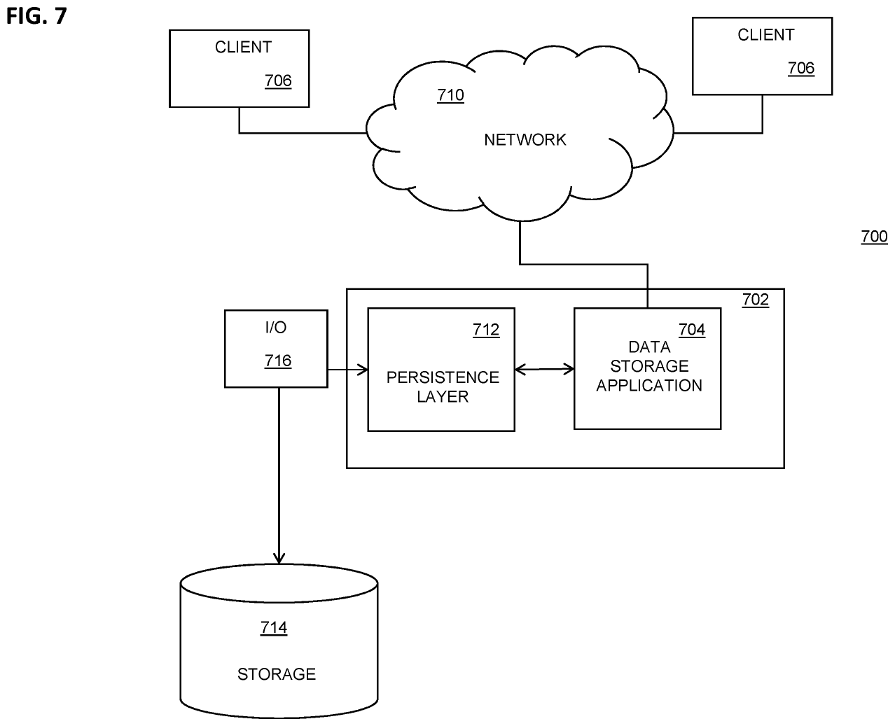

FIG. 7 illustrates an exemplary system 700 in which a computing system 702, which can include one or more programmable processors that can be collocated, linked over one or more networks, etc., executes one or more modules, software components, or the like of a data storage application 704, according to some implementations of the current subject matter. The data storage application 704 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 702 as well as to remote users accessing the computing system 702 from one or more client machines 706 over a network connection 710. One or more user interface screens produced by the one or more first modules can be displayed to a user, either via a local display or via a display associated with one of the client machines 706. Data units of the data storage application 704 can be transiently stored in a persistence layer 712 (e.g., a page buffer or other type of temporary persistency layer), which can write the data, in the form of storage pages, to one or more storages 714, for example via an input/output component 716. The one or more storages 714 can include one or more physical storage media or devices (e.g. hard disk drives, persistent flash memory, random access memory, optical media, magnetic media, and the like) configured for writing data for longer term storage. It should be noted that the storage 714 and the input/output component 716 can be included in the computing system 702 despite their being shown as external to the computing system 702 in FIG. 7.

Data retained at the longer term storage 714 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

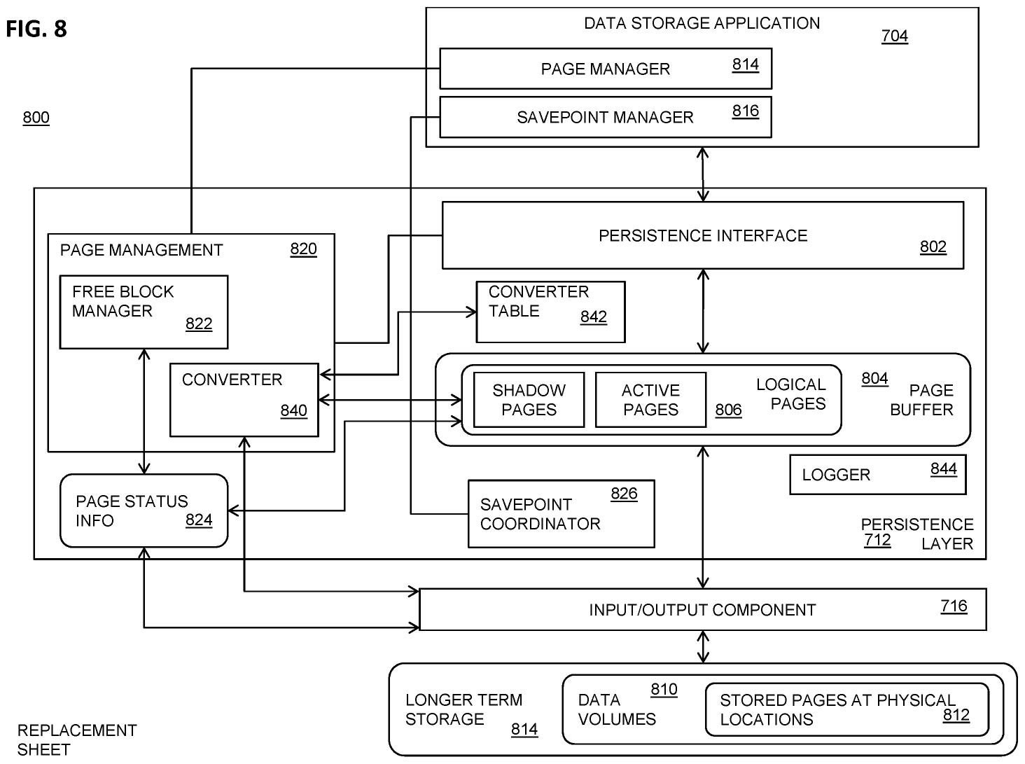

FIG. 8 illustrates exemplary software architecture 800, according to some implementations of the current subject matter. A data storage application 704, which can be implemented in one or more of hardware and software, can include one or more of a database application, a network-attached storage system, or the like. According to at least some implementations of the current subject matter, such a data storage application 704 can include or otherwise interface with a persistence layer 712 or other type of memory buffer, for example via a persistence interface 802. A page buffer 804 within the persistence layer 712 can store one or more logical pages 806, and optionally can include shadow pages, active pages, and the like. The logical pages 806 retained in the persistence layer 712 can be written to a storage (e.g. a longer term storage, etc.) 714 via an input/output component 716, which can be a software module, a sub-system implemented in one or more of software and hardware, or the like. The storage 714 can include one or more data volumes 810 where stored pages 812 are allocated at physical memory blocks.

In some implementations, the data storage application 704 can include or be otherwise in communication with a page manager 814 and/or a savepoint manager 816. The page manager 814 can communicate with a page management module 820 at the persistence layer 712 that can include a free block manager 822 that monitors page status information 824, for example the status of physical pages within the storage 714 and logical pages in the persistence layer 712 (and optionally in the page buffer 804). The savepoint manager 816 can communicate with a savepoint coordinator 826 at the persistence layer 712 to handle savepoints, which are used to create a consistent persistent state of the database for restart after a possible crash.

In some implementations of a data storage application 704, the page management module of the persistence layer 712 can implement a shadow paging. The free block manager 822 within the page management module 820 can maintain the status of physical pages. The page buffer 804 can include a fixed page status buffer that operates as discussed herein. A converter component 840, which can be part of or in communication with the page management module 820, can be responsible for mapping between logical and physical pages written to the storage 714. The converter 840 can maintain the current mapping of logical pages to the corresponding physical pages in a converter table 842. The converter 840 can maintain a current mapping of logical pages 806 to the corresponding physical pages in one or more converter tables 842. When a logical page 806 is read from storage 714, the storage page to be loaded can be looked up from the one or more converter tables 842 using the converter 840. When a logical page is written to storage 714 the first time after a savepoint, a new free physical page is assigned to the logical page. The free block manager 822 marks the new physical page as “used” and the new mapping is stored in the one or more converter tables 842.

The persistence layer 712 can ensure that changes made in the data storage application 704 are durable and that the data storage application 704 can be restored to a most recent committed state after a restart. Writing data to the storage 714 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 844 can also be included to store the changes made to the data of the data storage application in a linear log. The logger component 844 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 844 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 712 can use a combination of undo log entries (from one or more logs) and shadow paging.

The persistence interface 802 can handle read and write requests of stores (e.g., in-memory stores, etc.). The persistence interface 802 can also provide write methods for writing data both with logging and without logging. If the logged write operations are used, the persistence interface 802 invokes the logger 844. In addition, the logger 844 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 844. For an entry of type “update”, for example, this would be the identification of the affected record and the after image of the modified data.

When the data application 704 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 844 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 844 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 844 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 704 can use shadow paging so that the savepoint manager 816 can write a transactionally-consistent savepoint. With such an arrangement, a data backup comprises a copy of all data pages contained in a particular savepoint, which was done as the first step of the data backup process. The current subject matter can be also applied to other types of data page storage.

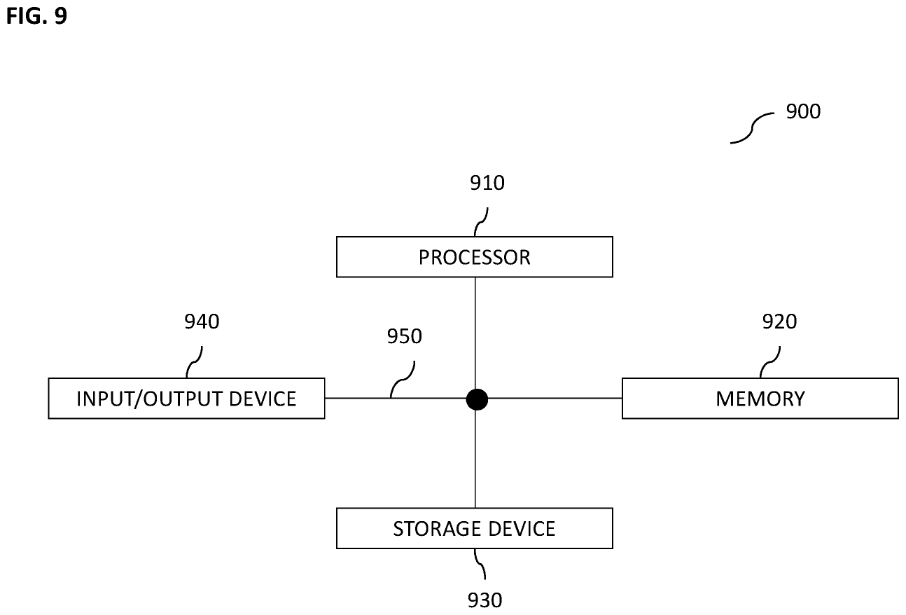

In some implementations, the current subject matter can be configured to be implemented in a system 900, as shown in FIG. 9. The system 900 can include a processor 910, a memory 920, a storage device 930, and an input/output device 940. Each of the components 910, 920, 930 and 940 can be interconnected using a system bus 950. The processor 910 can be configured to process instructions for execution within the system 900. In some implementations, the processor 910 can be a single-threaded processor. In alternate implementations, the processor 910 can be a multi-threaded processor. The processor 910 can be further configured to process instructions stored in the memory 920 or on the storage device 930, including receiving or sending information through the input/output device 940. The memory 920 can store information within the system 900. In some implementations, the memory 920 can be a computer-readable medium. In alternate implementations, the memory 920 can be a volatile memory unit. In yet some implementations, the memory 920 can be a non-volatile memory unit. The storage device 930 can be capable of providing mass storage for the system 900. In some implementations, the storage device 930 can be a computer-readable medium. In alternate implementations, the storage device 930 can be a floppy disk device, a hard disk device, an optical disk device, a tape device, non-volatile solid state memory, or any other type of storage device. The input/output device 940 can be configured to provide input/output operations for the system 900. In some implementations, the input/output device 940 can include a keyboard and/or pointing device. In alternate implementations, the input/output device 940 can include a display unit for displaying graphical user interfaces.

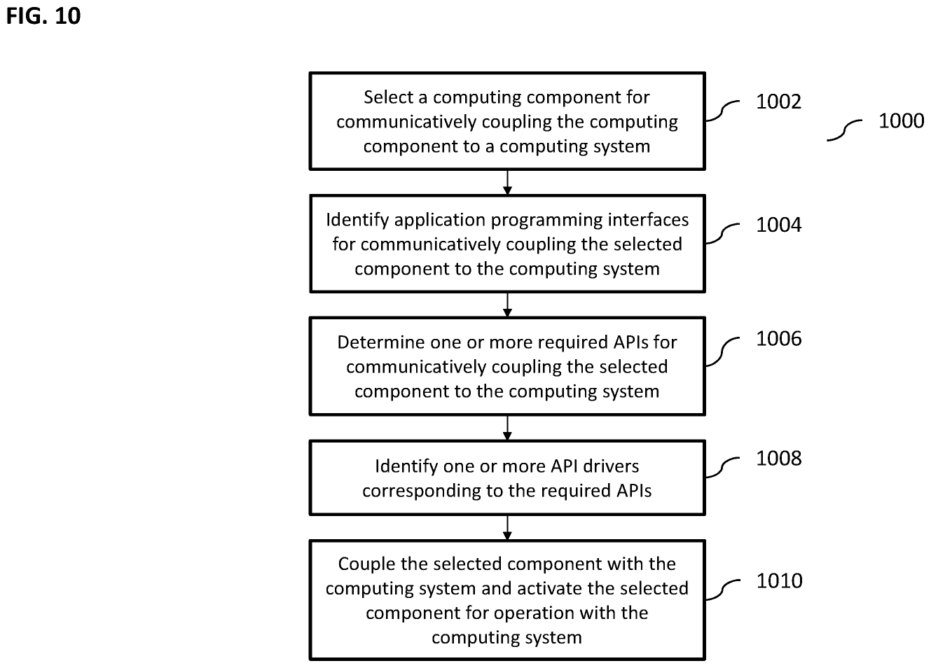

FIG. 10 illustrates an exemplary method 1000 for connecting various computing components, according to some implementations of the current subject matter. At 1002, a computing component (e.g., system 203 shown in FIG. 2) may be selected from a plurality of computing components for communicatively coupling the computing component to a computing system (e.g., system 206 shown in FIG. 2). At 1004, one or more application programming interfaces (APIs) for communicatively coupling the selected computing component to the computing system may be identified. At 1006, based on the identified APIs, one or more required APIs for communicatively coupling the selected computing component to the computing system may be determined. At 1008, one or more API drivers corresponding to the required APIs may be identified. At 1010, using the identified API drivers, the selected computing component may be communicatively coupled (e.g., using any communication protocol discussed above) with the computing system. Further, the selected component may be activated for operation with the computing system.

In some implementations, the current subject matter can include one or more of the following optional features. In some implementations, the computing system may include a plurality of bounded contexts. The selected computing component may be communicatively coupled with one or more bounded contexts in the plurality of bounded contexts.

In some implementations, the method may further include determining, based on the identified APIs, one or more optional APIs for communicatively coupling the selected computing component to the computing system, identifying one or more API drivers corresponding to the one or more optional APIs, and communicatively coupling, using the identified one or more API drivers corresponding to one or more required APIs and one or more optional APIs, the selected computing component with the computing system and activating the selected component for operation with the computing system.

In some implementations, the computing system may include a computing system API (e.g., an internal API) configured to be communicatively coupled to the identified one or more APIs.

In some implementations, the APIs may be identified based on at least one of the following: an operating system of the selected component, an operating system of the computing system, and any combination thereof.

In some implementations, the computing system may be an enterprise resource computing system.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
selecting a computing component from a plurality of computing components for communicatively coupling the computing component to a computing system;
identifying one or more application programming interfaces for communicatively coupling the selected computing component to the computing system;
determining, based on the identified one or more application programming interfaces, one or more required application programming interfaces for communicatively coupling the selected computing component to the computing system;
identifying one or more application programming interface drivers corresponding to the one or more required application programming interfaces, the one or more application programming interface drivers having a control component, the control component is configured to determine a version of the one or more determined required application programming interfaces for coupling the selected computing component with at least one bounded context of the computing system; and
communicatively coupling, using the identified one or more application programming interface drivers, the selected computing component with the computing system and activating the selected component for operation with the computing system.

2. The method according to claim 1, wherein the computing system includes a plurality of bounded contexts.

3. The method according to claim 2, wherein the selected computing component is communicatively coupled with one or more bounded context in the plurality of bounded contexts.

4. The method according to claim 1, further comprising
determining, based on the identified one or more application programming interfaces, one or more optional application programming interfaces for communicatively coupling the selected computing component to the computing system;
identifying one or more application programming interface drivers corresponding to the one or more optional application programming interfaces; and
communicatively coupling, using the identified one or more application programming interface drivers corresponding to the one or more required application programming interfaces and the one or more optional application programming interfaces, the selected computing component with the computing system and activating the selected component for operation with the computing system.

5. The method according to claim 1, wherein the computing system includes a computing system application programming interface configured to be communicatively coupled to the identified one or more application programming interfaces.

6. The method according to claim 1, wherein the one or more application programming interfaces are identified based on at least one of the following: an operating system of the selected component, an operating system of the computing system, and any combination thereof.

7. The method according to claim 1, wherein the computing system is an enterprise resource computing system.

8. A system comprising:
at least one programmable processor; and
a non-transitory machine-readable medium storing instructions that, when executed by the at least one programmable processor, cause the at least one programmable processor to perform operations comprising:
selecting a computing component from a plurality of computing components for communicatively coupling the computing component to a computing system;
identifying one or more application programming interfaces for communicatively coupling the selected computing component to the computing system;
determining, based on the identified one or more application programming interfaces, one or more required application programming interfaces for communicatively coupling the selected computing component to the computing system;
identifying one or more application programming interface drivers corresponding to the one or more required application programming interfaces, the one or more application programming interface drivers having a control component, the control component is configured to determine a version of the one or more determined required application programming interfaces for coupling the selected computing component with at least one bounded context of the computing system; and
communicatively coupling, using the identified one or more application programming interface drivers, the selected computing component with the computing system and activating the selected component for operation with the computing system.

9. The system according to claim 8, wherein the computing system includes a plurality of bounded contexts.

10. The system according to claim 9, wherein the selected computing component is communicatively coupled with one or more bounded context in the plurality of bounded contexts.

11. The system according to claim 8, wherein the operations further comprise
determining, based on the identified one or more application programming interfaces, one or more optional application programming interfaces for communicatively coupling the selected computing component to the computing system;
identifying one or more application programming interface drivers corresponding to the one or more optional application programming interfaces; and
communicatively coupling, using the identified one or more application programming interface drivers corresponding to the one or more required application programming interfaces and the one or more optional application programming interfaces, the selected computing component with the computing system and activating the selected component for operation with the computing system.

12. The system according to claim 8, wherein the computing system includes a computing system application programming interface configured to be communicatively coupled to the identified one or more application programming interfaces.

13. The system according to claim 8, wherein the one or more application programming interfaces are identified based on at least one of the following: an operating system of the selected component, an operating system of the computing system, and any combination thereof.

14. The system according to claim 8, wherein the computing system is an enterprise resource computing system.

15. A computer program product comprising a non-transitory machine-readable medium storing instructions that, when executed by at least one programmable processor, cause the at least one programmable processor to perform operations comprising:
selecting a computing component from a plurality of computing components for communicatively coupling the computing component to a computing system;
identifying one or more application programming interfaces for communicatively coupling the selected computing component to the computing system;
determining, based on the identified one or more application programming interfaces, one or more required application programming interfaces for communicatively coupling the selected computing component to the computing system;
identifying one or more application programming interface drivers corresponding to the one or more required application programming interfaces, the one or more application programming interface drivers having a control component, the control component is configured to determine a version of the one or more determined required application programming interfaces for coupling the selected computing component with at least one bounded context of the computing system; and
communicatively coupling, using the identified one or more application programming interface drivers, the selected computing component with the computing system and activating the selected component for operation with the computing system.

16. The computer program product according to claim 15, wherein the computing system includes a plurality of bounded contexts.

17. The computer program product according to claim 16, wherein the selected computing component is communicatively coupled with one or more bounded context in the plurality of bounded contexts.

18. The computer program product according to claim 15, wherein the operations further comprise
determining, based on the identified one or more application programming interfaces, one or more optional application programming interfaces for communicatively coupling the selected computing component to the computing system;
identifying one or more application programming interface drivers corresponding to the one or more optional application programming interfaces; and
communicatively coupling, using the identified one or more application programming interface drivers corresponding to the one or more required application programming interfaces and the one or more optional application programming interfaces, the selected computing component with the computing system and activating the selected component for operation with the computing system.

19. The computer program product according to claim 15, wherein the computing system includes a computing system application programming interface configured to be communicatively coupled to the identified one or more application programming interfaces.

20. The computer program product according to claim 15, wherein the one or more application programming interfaces are identified based on at least one of the following: an operating system of the selected component, an operating system of the computing system, and any combination thereof.
